(19) United States
(12) Patent Application Publication
(10) Pub. No.: US 2026/0270621 A1
(43) Pub. Date: Sep. 10, 2026

(54) SOUND GENERATING DEVICE

(71) Applicant: GOERTEK INC., Weifang, Shandong (CN)

(72) Inventors: Guodong ZHAO, Weifang, Shandong (CN); Shousong QIANG, Weifang, Shandong (CN); Jingwei WANG, Weifang, Shandong (CN); Jiacheng SHANG, Weifang, Shandong (CN)

(21) Appl. No.: 19/167,521

(22) PCT Filed: Mar. 25, 2024
(86) PCT No.: PCT/CN2024/083510

§ 371 Date: Sep. 22, 2025

(30) Foreign Application Priority Data
Mar. 31, 2023 (CN) 202310357685.4

(51) Int. Cl. H04R 9/04; H04R 7/12; H04R 9/02; H04R 9/06

(52) U.S. Cl. CPC H04R 9/041; H04R 7/12; H04R 9/025; H04R 9/045; H04R 9/046; H04R 9/06

(57) ABSTRACT

Disclosed is a sound generating device, comprising: a basket; a magnetic circuit system connected to an end of the basket and having a magnetic gap; a voice coil formed with a hollow and having an outer surface facing away from a side of the hollow; a diaphragm connected to the other end of the basket, an end of the voice coil being connected to the diaphragm, and the other end of the voice coil being suspended in the magnetic gap; a conductive connecting member disposed on the outer surface; and a conductive support plate, which is a planar support member, configured to transmit an electrical signal to the voice coil, the conductive support plate comprising a fixing member, an elastic arm, and a welding portion that are sequentially connected, the fixing member being connected to the voice coil and the welding portion being connected to the basket.

### TECHNICAL FIELD

The present application relates to a technical field of electro-acoustic conversion, and more particularly, to a sound generating device.

### DESCRIPTION OF RELATED ART

A loudspeaker is a basic sound generating unit that converts an electrical signal into an acoustic signal. A centering damper (spider) is a component of the loudspeaker that adjusts a vibration direction of a diaphragm, and suppresses off-axis displacement of the diaphragm through its mechanical restoring force. The performance of the centering damper has a significant influence on the acoustic performance and service life of the loudspeaker.

In the related art, the centering damper is annular, and the annular centering damper is formed in a corrugated structure in a radial direction. The centering damper is generally made of materials such as Conex, blended fabrics, or cloth, etc., and due to the limitation of the above material types, it is difficult to achieve very small mechanical stiffness (Kms). In the loudspeaker, since Kms and mechanical compliance of suspension (Cms) are reciprocal to each other, when a vibration amplitude is relatively large, the compliance Cms of the centering damper may be poor. This leads to an increased resonance frequency F0 of the loudspeaker. As F0 is an important factor affecting the acoustic performance of a loudspeaker, a higher F0 will lead to a poor bass sensitivity of the loudspeaker product. In addition, loudspeakers employing conventional centering dampers usually exhibit relatively high total harmonic distortion (THD), which degrades the acoustic performance of the loudspeaker and significantly affects the user experience.

Meanwhile, the voice coil lead wire is guided from above the centering damper to an external pad through a tinsel wire. Therefore, during the manufacturing process of the centering damper, a routing path must be provided for the tinsel wire, making the manufacturing steps of the existing loudspeaker complicated.

### SUMMARY

A main object of the present disclosure is to provide a sound generating device, which aims to provide a sound generating device with improved acoustic performance and extended service life.

To achieve the above object, the present disclosure provides a sound generating device, including: a basket; a magnetic circuit system connected to an end of the basket and having a magnetic gap; a voice coil formed with a hollow and having an outer surface facing away from a side of the hollow; a diaphragm connected to the other end of the basket, an end of the voice coil is connected to the diaphragm, and the other end of the voice coil is suspended in the magnetic gap; a conductive connecting member disposed on the outer surface; and a conductive support plate, which is a planar support member, configured to transmit an electrical signal to the voice coil, the conductive support plate includes a fixing member, an elastic arm, and a welding portion that are sequentially connected, the fixing member is connected to the voice coil through the conductive connecting member, the elastic arm extends along a circumferential direction of the voice coil, and the welding portion is connected to the basket.

In an embodiment, the diaphragm, the basket, and the magnetic circuit system define a vibration space, the conductive support plate is positioned in the vibration space, the magnetic circuit system is further provided with an avoidance notch at a position corresponding to the conductive connecting member, the avoidance notch communicates the vibration space and the magnetic gap, and the avoidance notch is configured to prevent the conductive connecting member and the conductive support plate from interfering with the vibration displacement of the voice coil within the magnetic gap.

In an embodiment, a part of the conductive connecting member is positioned in the avoidance notch and is connected to the fixing member.

In an embodiment, the magnetic circuit system includes a U-shaped iron and a central magnetic circuit part, the U-shaped iron is provided with a receiving groove, the central magnetic circuit part is positioned in the receiving groove and spaced apart from a side wall of the receiving groove and the magnetic gap is formed therebetween, and the avoidance notch is provided on a side wall of the U-shaped iron.

In an embodiment, an angle of the avoidance notch is in a range from 15° to 27°.

In an embodiment, the elastic arm extends around an outer peripheral side of the U-shaped iron.

In an embodiment, a plurality of conductive connecting members are provided, the plurality of conductive connecting members are arranged at intervals on the outer surface and distributed at intervals along the circumferential direction of the voice coil, and the magnetic circuit system is provided with an avoidance notch for each of the plurality of conductive connecting members.

In an embodiment, the conductive support plate includes a plurality of conductive support plates, and the fixing member of each of the plurality of conductive support plate is connected to a respective conductive connecting member.

In an embodiment, a plurality of elastic arms of the plurality of conductive support plate extend along a same circumferential direction of the voice coil.

In an embodiment, the voice coil has a cylindrical shape, four conductive connecting members and four conductive support plate are included, and the four conductive connecting members are spaced apart and evenly distributed along the circumferential direction of the voice coil, such that an included angle formed by lines connecting any two adjacent conductive connecting members and a center of the voice coil is 90°, or, three conductive connecting members are included, and the three conductive connecting members are spaced apart and evenly distributed along the circumferential direction of the voice coil, such that an included angle formed by lines connecting any two adjacent conductive connecting members and the center of the voice coil is 120°.

In an embodiment, the voice coil has a cylindrical shape and has a diameter of 14 mm to 28 mm.

In an embodiment, the diaphragm has a diameter of 40 mm to 75 mm.

In an embodiment, the voice coil includes a bobbin and a voice coil wire disposed on the bobbin.

In an embodiment, the vibration displacement of the voice coil ranges from 1 mm to 15 mm.

In an embodiment, a plurality of conductive support plates are included, each of the plurality of elastic arms includes a first arc segment, a second arc segment and a third arc segment connected in sequence, the first arc segment is connected to the fixing member, the third arc segment is connected to the welding portion, and the second arc segment extends from the first arc segment to the third arc segment along the circumferential direction of the voice coil, such that the third arc segment and the welding portion of a respective conductive support plate can correspond to and are spaced apart from the fixing member of another conductive support plate.

In an embodiment, curvature centers of the first arc segment and the second arc segment and a curvature center of the third arc segment are located on opposite sides of the second arc segment.

In an embodiment, an arc angle of the first arc segment is greater than 90°, and an arc angle of the second arc segment is less than 90°.

In an embodiment, a minimum gap distance between the third arc segment and the fixing member of another conductive support plate is greater than 1 mm.

In an embodiment, a width of the first arc segment gradually decreases from the fixing member to the second arc segment, a width of the second arc segment gradually decreases from the first arc segment to the third arc segment, and a width of the third arc segment gradually increases from the second arc segment toward an end away from the second arc segment.

In an embodiment, the width of the first arc segment is constant from the fixing member to the second arc segment, the width of the second arc segment gradually decreases from the first arc segment to the third arc segment, and the width of the third arc segment gradually increases from the second arc segment toward an end away from the second arc segment.

In an embodiment, the width of the first arc segment is constant from the fixed portion to the second arc segment, the width of the second arc segment decreases first and then increases from the first arc segment to the third arc segment, and the width of the third arc segment gradually increases from the second arc segment toward an end away from the second arc segment.

In an embodiment, the width of the first arc segment, the width of the second arc segment, and the width of the third arc segment are the same.

In an embodiment, a width of the fixing member ranges from 1 mm to 3 mm.

In an embodiment, a width of the elastic arm ranges from 1 mm to 3 mm.

In an embodiment, the conductive support plate has a thickness ranging from 0.3 mm to 1 mm.

In an embodiment, a length of the conductive support plate is ≥30 mm.

In an embodiment, a mechanical stiffness Kms of the conductive support plate ranges from 0.1 N/mm to 1 N/mm.

In an embodiment, the conductive support plate includes: a FPCB layer having a first surface and a second surface opposite to each other; and a reinforcing layer adhered to the first surface and/or the second surface by an adhesive layer.

In an embodiment, the adhesive layer is a thermosetting adhesive or an acrylic adhesive.

In an embodiment, the reinforcing layer is made of at least one of PI, PEN, PET and PEI.

In an embodiment, the reinforcing layer has a thickness ranging from 0.1 mm to 0.5 mm.

In an embodiment, the adhesive layer has a thickness ranging from 0.015 mm to 0.1 mm.

In an embodiment, the FPCB layer includes a substrate layer, a copper layer, and a cover film layer stacked in sequence, a side of the substrate layer facing away from the copper layer forms the first surface, and a side of the cover film layer facing away from the copper layer forms the second surface.

In an embodiment, the FPCB layer includes a substrate layer, two copper layers, and two cover film layers, the substrate layer is sandwiched between the two copper layers, each of the two cover film layers is disposed on a side of each of the two copper layers facing away from the substrate layer, and a side of the cover film layer facing away from the copper layer forms the first surface or the second surface.

In an embodiment, the conductive connecting member includes a first connecting portion and a second connecting portion arranged at an angle, the first connecting portion is connected to the outer surface, and the second connecting portion is connected to the fixing member.

In an embodiment, the first connecting portion and the second connection portion are provided perpendicular to each other.

In an embodiment, the second connecting portion is connected to an end of the first connecting portion close to the diaphragm, and the fixing member is perpendicular to the outer surface of the voice coil.

In an embodiment, a width of the second connecting portion is greater than a width of the first connecting portion.

In an embodiment, the width of the first connecting portion gradually decreases from an end adjacent to the second connecting portion to an end away from the second connecting portion.

In an embodiment, the width of the second connecting portion is the same as the width of the fixing member.

In an embodiment, the outer surface is provided with an inner pad at a position corresponding to the conductive connecting member, and the first connecting portion is welded to the inner pad.

In an embodiment, the conductive connecting member is a metal sheet.

In an embodiment, the conductive connecting member has a thickness ranging from 0.1 mm to 0.5 mm.

In an embodiment, an end of the second connecting portion away from the first connecting portion is bent toward a direction away from the first connecting portion to form a support bracket, the support bracket is configured to support an end of the elastic arm adjacent to the fixing member.

In an embodiment, an end of the second connecting portion away from the first connecting portion is bent toward a side of the fixing member to form a flange, the flange and the second connecting portion define a mounting groove, and the fixing member is accommodated and positioned in the mounting groove.

In an embodiment, an end of the second connecting portion away from the first connecting portion is provided with a welding hole for connecting the second connecting portion and the fixing member by welding.

In an embodiment, the basket is provided with an outer pad, the welding portion is connected to the outer pad, the basket is provided with an avoidance hole corresponding to the outer pad, and the welding portion is connected to the outer pad through the avoidance hole.

In an embodiment, the basket has an opening and a support portion located in the opening, and the welding portion is fixed to the support portion and connected to an external circuit.

In an embodiment, the basket has an opening and a support portion located in the opening, and the welding portion is fixed to the support portion and connected to an external circuit.

In an embodiment, the welding portion is provided with a positioning hole, and the support portion is provided with a positioning pin to be coupled to the positioning hole.

In an embodiment, two support portions spaced apart from each other are included, and a spacing therebetween forms a welding groove for welding the welding portion with an external circuit.

In an embodiment, the basket includes a bottom wall and a side wall, and the opening is disposed on the side wall and extends to the bottom wall.

In an embodiment, a resonant frequency F0 of the sound generating device ranges from 30 Hz to 300 Hz, and a total harmonic distortion THD of the sound generating device is less than 15%.

In an embodiment, the resonant frequency F0 ranges from 100 Hz to 300 Hz, the total harmonic distortion THD of the sound generating device is less than 10%.

In an embodiment, the resonant frequency F0 is 200 Hz, the total harmonic distortion THD of the sound generating device is less than 2.5%.

In an embodiment, the resonant frequency F0 is 300 Hz, the total harmonic distortion THD of the sound generating device is less than 2%.

In the sound generating device of the technical solution of the present disclosure, the magnetic circuit system is connected to an end of the basket, the diaphragm is connected to the other end of the basket, and the voice coil is formed with a hollow, a conductive connecting member is arranged on the outer surface of the voice coil, and a conductive support plate is provided as a planar support member, such that the fixing member of the conductive support plate is connected to the voice coil through the conductive connecting member, and the elastic arm extends along the circumferential direction of the voice coil, and is connected to the basket through the welding portion, so that conductive connection can be connected to the voice coil through the conductive support plate and the conductive connecting member, thereby transmitting an electrical signal to the voice coil. On another aspect, the planar support member not only provides a centering function for the voice coil, but also achieve a transmission of an electrical signal to the voice coil. The use of the planar support member not only eliminates connecting the voice coil by using the elastic centering damper and the tinsel wire, which is adopted in the related art, but also effectively simplifies the processing steps of the sound generating device, reduces the production costs, and the planar support member can obtain a smaller Kms. Compared with the sound generating device according to the related art, the F0 of the sound generating device is made lower, and thus a better acoustic performance can be obtained, and the service life of the sound generating device can be effectively extended.

### BRIEF DESCRIPTION OF DRAWINGS

In order to more clearly illustrate the embodiments of the present disclosure or the technical solutions in the related art, the drawings required to be used for the content of the embodiments or the related art will be briefly introduced in the following. Obviously, the drawings in the following description are merely some embodiments of the present disclosure and for those of ordinary skill in the art, other drawings can also be obtained from the provided drawings without any creative effort.

FIG. 1 is a schematic structural diagram of a sound generating device according to an embodiment of the present disclosure.

FIG. 2 is an exploded view of a sound generating device according to an embodiment of the present disclosure.

FIG. 3 is a schematic cross-sectional view of a sound generating device according to an embodiment of the present disclosure.

FIG. 4 is a schematic structural diagram of a sound generating device from which a diaphragm is removed according to an embodiment of the present disclosure.

FIG. 5 is a schematic structural diagram of a sound generating device according to another embodiment of the present disclosure.

FIG. 6 is an exploded view of a sound generating device according to another embodiment of the present disclosure.

FIG. 7 is a schematic cross-sectional view of a sound generating device according to another embodiment of the present disclosure.

FIG. 8 is a schematic structural diagram of a sound generating device from which a diaphragm is removed according to another embodiment of the present disclosure.

FIG. 9 is a schematic structural diagram of a sound generating device with a diaphragm and a basket removed according to an embodiment of the present disclosure.

FIG. 10 is a schematic structural diagram of connection between a voice coil and a conductive support plate according to an embodiment of the present disclosure.

FIG. 11 is a schematic structural diagram of connection between a voice coil and a conductive support plate according to another embodiment of the present disclosure.

FIG. 12 is a schematic structural diagram of a conductive connecting member according to an embodiment of the present disclosure.

FIG. 13 is a schematic structural diagram of a conductive connecting member according to another embodiment of the present disclosure.

FIG. 14 is a schematic structural diagram of a conductive support plate according to an embodiment of the present disclosure.

FIG. 15 is a schematic structural diagram of a conductive support plate according to another embodiment of the present disclosure.

FIG. 16 is a schematic structural diagram of a conductive support plate according to still another embodiment of the present disclosure.

FIG. 17 is a schematic structural diagram of a conductive support plate according to yet another embodiment of the present disclosure.

FIG. 18 is an exploded view of a conductive support plate according to an embodiment of the present disclosure.

FIG. 19 is an exploded view of a conductive support plate according to another embodiment of the present disclosure.

FIG. 20 is a schematic cross-sectional view of a FPCB layer according to an embodiment of the present disclosure.

FIG. 21 is a schematic cross-sectional view of a FPCB layer according to another embodiment of the present disclosure.

FIG. 22 is a schematic cross-sectional view of a basket according to an embodiment of the present disclosure.

### DESCRIPTION OF REFERENCE NUMERALS

| Reference | | Reference | |
|---|---|---|---|
| numeral | Name | numeral | Name |
| 100 | sound generating device | 343 | cover film layer |
| 1 | voice coil | 35 | reinforcement layer |
| 11 | hollow | 36 | adhesive layer |
| 12 | outer surface | 4 | diaphragm |
| 13 | inner pad | 5 | basket |
| 14 | bobbin | 51 | cavity |
| 15 | voice coil wire | 52 | outer pad |
| 2 | conductive connecting | 53 | avoidance hole |
| | member | | |
| 21 | first connection portion | 54 | opening |
| 22 | second connecting portion | 55 | support portion |
| 23 | support bracket | 551 | positioning pin |
| 3 | conductive support plate | 552 | welding groove |
| 31 | fixing member | 56 | bottom wall |
| 32 | elastic arm | 57 | side wall |
| 321 | first arc segment | 6 | magnetic circuit |
| | | | system |
| 322 | second arc segment | 61 | magnetic gap |
| 323 | third arc segment | 62 | U-shaped iron |
| 33 | welding portion | 621 | avoidance notch |
| 331 | positioning hole | 622 | receiving groove |
| 34 | FPCB layer | 63 | central magnetic |
| | | | circuit part |
| 341 | substrate layer | 7 | vibration space |
| 342 | copper layer | | |

The implementation, functional features and advantages of the present disclosure will be further described with reference to the accompanying drawings in combination with the embodiments.

### DETAILED DESCRIPTIONS

The following clearly and completely describes the technical solutions in the embodiments of the present disclosure with reference to the accompanying drawings in the embodiments of the present disclosure, and obviously, the described embodiments are only a part of the embodiments of the present disclosure, but not all the embodiments. Based on the embodiments of the present disclosure, all other embodiments obtained by those skilled in the art without creative efforts fall within the protection scope of the present disclosure.

It should be noted that all directional indications (such as up, down, left, right, front, and rear) in the embodiments of the present disclosure are merely used to explain a relative position relationship and a movement condition and the like between components in a specific posture (as shown in the accompanying drawings), and if the specific posture changes, the directional indication changes accordingly.

In addition, “and/or” appearing throughout the text means that three parallel solutions are included, for example, “A and/or B” includes A solution, B solution, or solution that satisfies A and B simultaneously.

In addition, in the embodiments of the present disclosure, descriptions such as “first”, “second” and the like are merely used for description purposes, and cannot be understood as indicating or implying relative importance thereof or implicitly indicating a quantity of indicated technical features. Thus, a feature defining with “first” and “second” may explicitly or implicitly include at least one of the features. In addition, the technical solutions among the various embodiments may be combined with each other, but must be based on the fact that the technical solutions can be realized by those of ordinary skill in the art, and when the combination of the technical solutions contradicts or cannot be realized, it should be considered that the combination of the technical solutions does not exist or fall within the protection scope claimed by the present disclosure.

A loudspeaker is a basic sound generating unit that converts an electrical signal into an acoustic signal. A centering damper is a component in the loudspeaker that adjusts a vibration direction of a diaphragm, and off-axis displacement polarization of the diaphragm by a mechanical restoring force. The performance of the centering damper has a significant influence on the acoustic performance and service life of the loudspeaker.

In the related art, the centering damper is annular, and the annular centering damper is arranged in a corrugated structure in a radial direction. The centering damper is generally made of materials such as Conex, blended fabrics, cloth, etc., and due to the limitation of the above material types, it is difficult to achieve very small Kms. In the loudspeaker, since Kms and Cms are reciprocal to each other, when a vibration amplitude is large, the compliance Cms of the centering damper may be poor. This makes a resonant frequency F0 of the loudspeaker larger. Since F0 is an important factor affecting the acoustic performance of the loudspeaker, a larger F0 will lead to a poor bass sensitivity of the loudspeaker product. Meanwhile, a total harmonic distortion THD of the loudspeaker using the traditional centering damper is high. With such configuration, the acoustic performance of the loudspeaker is reduced, and user experience is greatly deteriorated.

In addition, since the material of the centering damper is generally chemical fiber, blended fabrics, etc., the hardness of the centering damper increases in a high-temperature and humid environment. This causes the centering damper to be easily deformed or even broken, and the fatigue performance of the centering damper is reduced. The failure of the centering damper will directly lead to the failure of the loudspeaker, which significantly shortens the service life of the loudspeaker.

Meanwhile, the voice coil lead of the loudspeaker is guided from above the centering damper to an external pad through the tinsel wire, and the centering damper needs to set a straight path for the wiring of the tinsel wire during processing, resulting in complicated processing steps of the existing loudspeaker.

Based on the above concepts and problems, the present disclosure provides a sound generating device 100. The sound generating device 100 may be applied to a terminal device such as a sound box, a television, or an automobile.

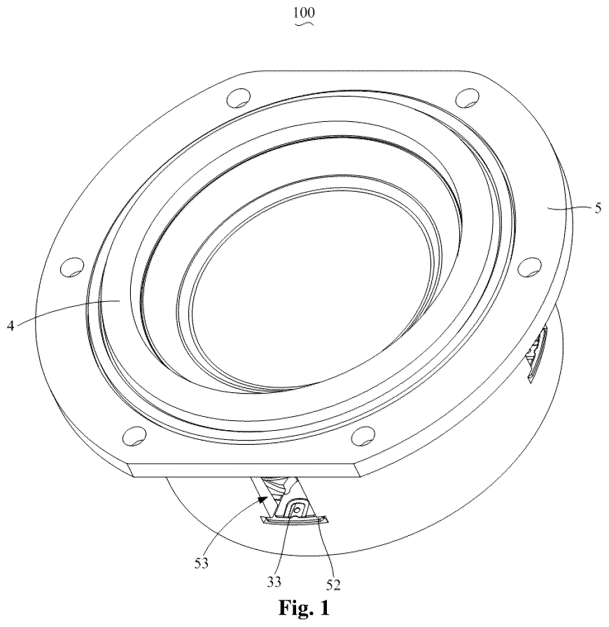

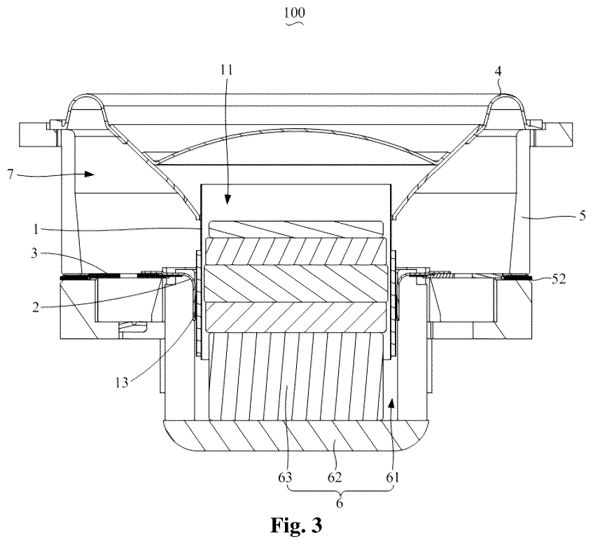

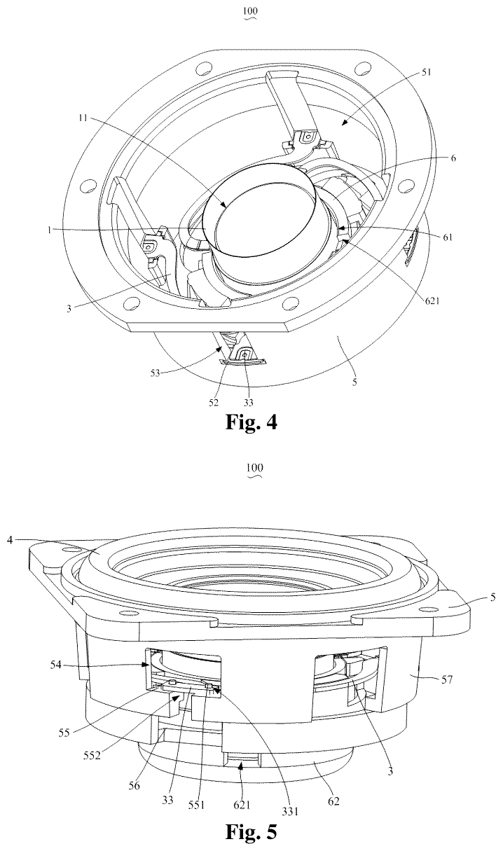

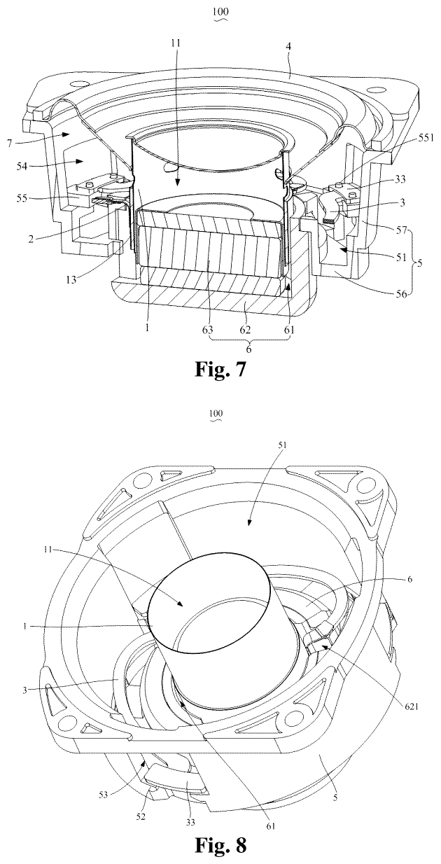

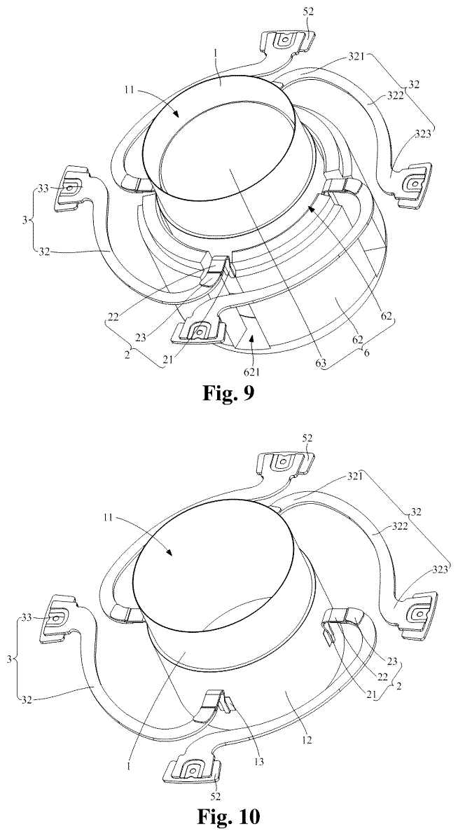

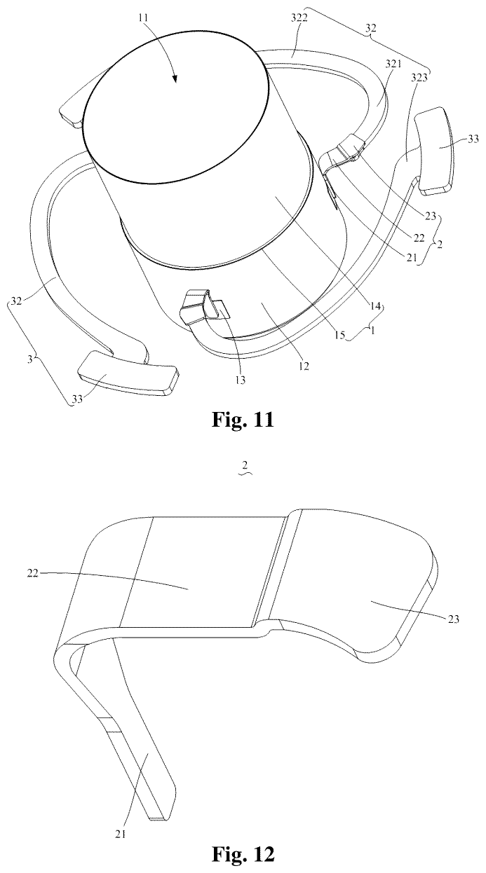

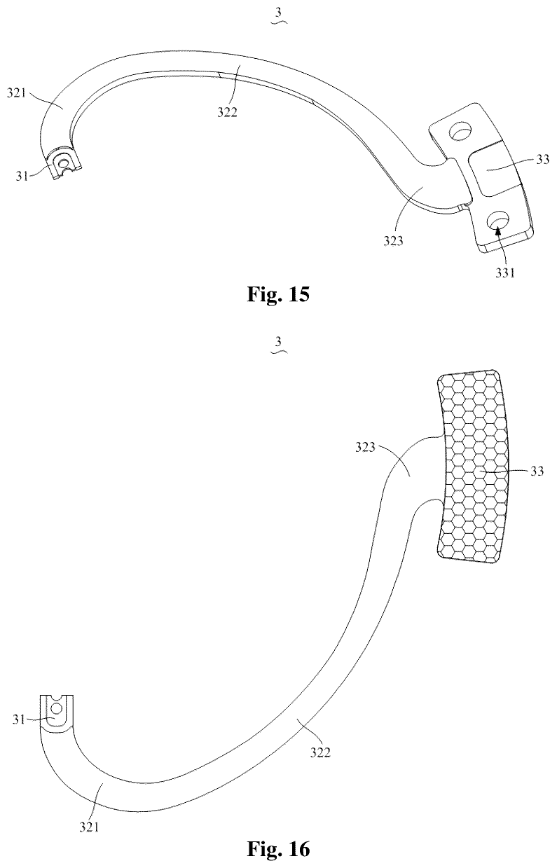

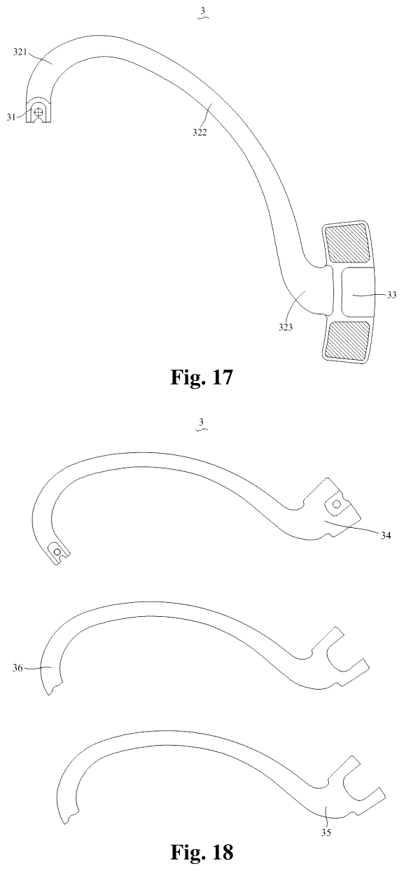

Referring to FIGS. 1 to 22, in an embodiment of the present disclosure, the sound generating device 100 includes a basket 5, a magnetic circuit system 6, a voice coil 1, a diaphragm 4, a conductive connecting member 2 and a conductive support plate 3. The magnetic circuit system 6 is connected to an end of the basket 5, the magnetic circuit system 6 has a magnetic gap 61. The voice coil 1 is formed with a hollow 11, and has an outer surface 12 facing away from the hollow 11. The diaphragm 4 is connected to the other end of the basket 5, and an end of the voice coil 1 is connected to the diaphragm 4, and the other end of the voice coil 1 is suspended in the magnetic gap 61. The conductive connecting member 2 is disposed on the outer surface 12. The conductive support plate 3 is a planar support member for transmitting an electrical signal to the voice coil 1. The conductive support plate 3 includes a fixing member 31, an elastic arm 32 and a welding portion 33 that are sequentially connected. The fixing member 31 is connected to the voice coil 1 through the conductive connecting member 2. The elastic arm 32 extends along a circumferential direction of the voice coil 1, and the welding portion 33 is connected to the basket 5.

It should be understood that the voice coil 1 of the sound generating device 100 may be configured to transmit an electrical signal. In this embodiment, the voice coil 1 may be cylindrical. The voice coil 1 has a hollow 11, and the hollow 11 may be a hollow cavity, that is, both ends of the hollow 11 have an opening, and the opening communicates with the hollow cavity. The voice coil 1 has an outer surface 12 facing away from a side of the hollow 11 and an inner surface facing the side of the hollow 11, and the voice coil 1 further has ends at both ends. Optionally, an end of the voice coil 1 is connected to the diaphragm 4, and the other end of the voice coil 1 is suspended in the magnetic gap 61 of the magnetic circuit system 6.

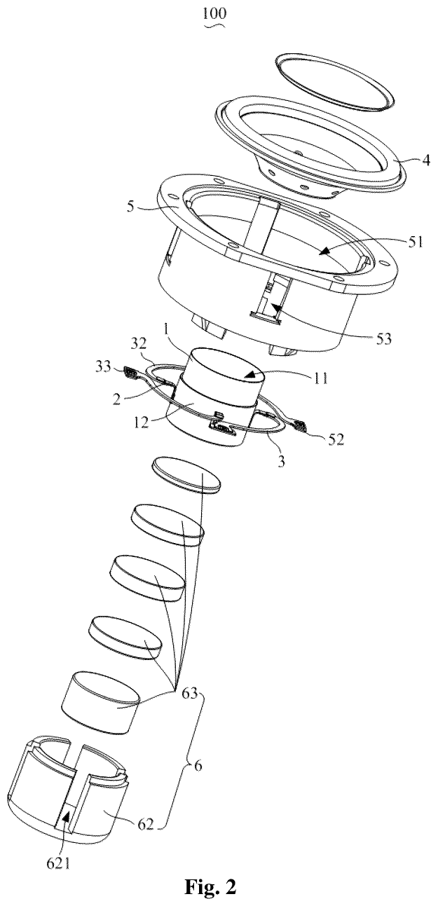

In an embodiment, as shown in FIGS. 2, 3, 6, 7, 10, and 11, the voice coil 1 includes a bobbin 14 and a voice coil wire 15 disposed on the bobbin 14. Optionally, the voice coil 1 is a structure formed by winding the voice coil wire 15 on the bobbin 14. In this embodiment, the voice coil wire 15 may be made of a metal material capable of introducing a current. The bobbin 14 of the voice coil 1 may be of a circular cylinder, a square cylinder, a racetrack, or other cylindrical shapes, but the present disclosure is not limited to it.

In order to facilitate the connection between the voice coil 1 and the planar conductive support plate 3, and improve the connection stability and the conductive smoothness, in this embodiment, the outer surface 12 of the voice coil 1 is provided with a conductive connecting member 2. It should be understood that the conductive connecting member 2 may be integrally formed on the outer surface 12 of the voice coil 1, so that connection stability and conductive smoothness between the voice coil 1 and the conductive connecting member 2 can be improved. Of course, the conductive connecting member 2 and the voice coil 1 may also be provided separately, and the conductive connecting member 2 is fixed to the outer surface 12 of the voice coil 1 by means of a fixing member or a connecting member, but the present disclosure is not limited to it.

Optionally, the outer surface 12 of the voice coil 1 is provided with an inner pad 13 at a position corresponding to the conductive connecting member 2, and the conductive connecting member 2 is fixedly connected to the inner pad 13, for example, by welding or the like, but the present disclosure is not limited to it.

In this embodiment, by setting the conductive support plate 3 as a planar support member, on the one hand, the processing is convenient and the processing steps are simplified, and on the other hand, the conductive support plate 3 not only provides a centering function for the voice coil 1, thereby effectively suppressing the polarization of the diaphragm 4, but also realize the conductive communication between the voice coil 1 and the external circuit through the conductive support plate 3.

It should be noted that in a micro loudspeaker, the vibration displacement of the voice coil 1 is less than 1 mm. In a large-horn loudspeaker, the vibration displacement of the voice coil 1 is greater than 1 mm. In this embodiment, the vibration displacement of the voice coil 1 may be 1 mm to 15 mm, that is, the sound generating device 100 is a large-horn loudspeaker. Optionally, the vibration displacement of the voice coil 1 is 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, etc., but the present disclosure is not limited to it. The vibration displacement of the voice coil 1 refers to a stable displacement during normal operation of the sound generating device 100, and does not include a situation that the displacement of the voice coil 1 suddenly changes when the voice coil 1 receives abnormal current or other abnormal conditions occur in the sound generating device 100.

However, the centering damper used in the traditional sound generating device is an elastic centering damper. That is, the elastic centering damper is of an annular structure and is sleeved on the periphery of the voice coil, and the elastic centering damper is arranged in a corrugated shape in a radial direction thereof, which is not only cumbersome in processing steps, but also cannot be electrically connected to the voice coil, and it is necessary to additionally arrange a tinsel wire to be connected with the voice coil lead so as to conduct the voice coil with an external circuit. Meanwhile, the tinsel wire is positioned above the elastic centering damper, and a routing space structure that facilitates wiring of the tinsel wire needs to be disposed above the elastic centering damper, and a routing space needs to be reserved for the tinsel wire, thereby further causing complex processing steps of the centering damper and a more complex structure of the sound generating device.

Compared with the traditional elastic centering damper and tinsel wire structure, the planar conductive support plate 3 of the present disclosure effectively simplifies the structure and processing steps, saves the cost, and can obtain smaller Kms, and compared with the related art, the F0 of the sound generating device 100 is lower, so that good acoustic performance can be obtained, and the service life of the sound generating device 100 can be effectively prolonged. Meanwhile, the sound generating device 100 of the present disclosure does not need to reserve a routing space for the traditional tinsel wire, which can reduce the thickness of the sound generating device 100 and facilitate the thinning design of the sound generating device 100.

It should be understood that the conductive support plate 3 is provided as the fixing member 31, the elastic arm 32 and the welding portion 33 that are connected, so that the fixing member 31 of the conductive support plate 3 is connected to the voice coil 1 through the conductive connecting member 2, thereby improving the connection stability between the conductive support plate 3 and the conductive connecting member 2. Meanwhile, the elastic arm 32 extends along the circumferential direction of the voice coil 1, which not only improves the deformation capability of the conductive support plate 3, that effectively avoids the breakage of the conductive support plate 3, but also helps to disperse the stress concentrating on the fixing member 31 of the conductive support plate 3, and can be connected to the external pad of the sound generating device 100 through the welding portion 33, thereby facilitating the smooth introduction of the current of the external circuit into the voice coil 1. For example, the external pad may be disposed on the sound generating device 100, and the welding portion 33 is electrically connected to an external circuit through the external pad. Alternatively, the external pad is a pad of an external electrical connector, and the welding portion 33 is connected to the pad of the external electrical connector, and a current of the external circuit is smoothly introduced into the voice coil 1.

In this embodiment, an end of the conductive support plate 3 is provided as the fixing member 31, a voice coil 1 is mounted in the sound generating device 100, and the fixing member 31 is connected to the conductive connecting member 2 of the voice coil 1 of the sound generating device 100. Optionally, the voice coil 1 includes a voice coil body and a bobbin 14, both of which are tubular structures. The voice coil body is a coil wound on the bobbin 14, and the bobbin 14 is configured to support the voice coil body. The conductive connecting member 2 may be connected to the bobbin or the voice coil body. The other end of the conductive support plate 3 is provided as the welding portion 33, and the welding portion 33 is fixed on the sound generating device 100.

Optionally, the sound generating device 100 further includes a basket 5, and the welding portion 33 is fixed on the basket 5. The fixing member 31 bends and extends toward the welding portion 33 to form an elastic arm 32 connected between the fixing member 31 and the welding portion 33. Optionally, the elastic arm 32 has a capability of being elastically deformed. The conductive support plate 3 is connected to the conductive connecting member 2 of the voice coil 1 through the fixing member 31, and the welding portion 33 is connected to the basket 5 of the sound generating device 100 as the conductive support plate 3 of the sound generating device 100, so as to adjust the vibration of the sound generating device 100 and performs a centering function for the voice coil 1. When the elastic arm 32 has elastic deformation capability, it has a better polarization adjustment function.

In an embodiment, the mechanical stiffness Kms of the conductive support plate 3 may be 0.1 N/mm to 1 N/mm. The mechanical stiffness Kms is the reciprocal of compliance, which reflects the compliance of the conductive support plate 3 to the driving force, and Kms is an important factor affecting the acoustic performance of the sound generating device 100. The mechanical stiffness Kms of the conductive support plate 3 of the present disclosure ranges from 0.1 N/mm to 1 N/mm. Within this mechanical stiffness range, the conductive support plate 3 has good compliance with the driving force, and will not be plastically deformed to cause damage when the sound generating device 100 vibrates with a large displacement. Therefore, when the mechanical stiffness of the conductive support plate 3 ranges from 0.1 N/mm to 1 N/mm, the sound generating device 100 can obtain better acoustic performance.

Optionally, the resonance frequency F0 of the sound generating device 100 ranges from 30 Hz to 300 Hz. The resonant frequency F0 is an important parameter that affects the low-frequency performance of the sound generating device 100, and its calculation formula is as follows: F0=1/2π\sqrt{Kms/Mms}. Here, F0 represents the resonance frequency, π is pi (the mathematical constant), Kms represents mechanical stiffness, and Mms represents equivalent mass.

It can be seen from the above formula that Kms (mechanical stiffness) and Mms (equivalent mass) are two factors that affects F0, and the smaller Kms, the smaller the resonance frequency F0, and the better the acoustic performance of the sound generating device 100. The larger the Mms, the smaller the resonant frequency F0. In the related art, in order to obtain a smaller mechanical stiffness, it is necessary to put forward a higher requirement on the performance of the material, which undoubtedly increases the manufacturing cost of the sound generating device 100. On the other hand, if the resonance frequency F0 is reduced by increasing the equivalent mass of the sound generating device 100, not only the principle of product weight is violated, but also other performances of the sound generating device 100 are adversely affected. Therefore, in the present disclosure, the resonant frequency F0 is limited to be in the range from 30 Hz to 300 Hz, so that the sound generating device 100 can obtain good low-frequency acoustic performance, and the product manufacturing cost of the sound generating device 100 and the relationship between other performances and low-frequency acoustic performance can be balanced.

According to an embodiment of the present disclosure, the impedance of the sound generating device 100 using the existing centering damper and the conductive support plate 3 is detected, and when the conventional centering damper is used, the detected resonant frequency F0 of the sound generating device 100 is about 90 Hz. However, according to the present disclosure, by replacing the existing centering damper with the conductive support plate 3, the resonance frequency F0 of the sound generating device 100 is lowered to about 65 Hz. It can be seen that using the conductive support plate 3 as the centering damper of the sound generating device 100 can significantly reduce the resonance frequency F0 of the sound generating device 100, improve the bass sensitivity, and improve the acoustic performance of the sound generating device 100.

A total harmonic distortion THD is a parameter reflecting the sound fidelity of the sound generating device 100, and the larger the value, the more serious the sound distortion of the sound generating device 100, and the worse the listening effect of the sound generating device 100. Therefore, in order to obtain a good listening feeling, the sound generating device 100 is required to have a smaller total harmonic distortion THD. According to an embodiment of the present disclosure, the total harmonic distortions THD of the sound generating device 100 using the existing centering damper and the conductive support plate 3 are detected, and when the frequency is lower than 1000 Hz, the total harmonic distortion THD of the sound generating device 100 detected using the conventional centering damper is significantly higher than the total harmonic distortion THD of the sound generating device 100 using the conductive support plate 3. Moreover, the lower the frequency band, the larger the difference between the two, and the more obvious the improvement effect on the total harmonic distortion THD of the sound generating device 100. Therefore, the use of the conductive support plate 3 of the present disclosure as the conductive support plate 3 of the sound generating device 100 can significantly improve the sound reproduction accuracy (sound fidelity) and improve the listening effect of the sound generating device 100.

In an embodiment, the resonance frequency F0 of the sound generating device 100 ranges from 30 Hz to 300 Hz, and the total harmonic distortion THD of the sound generating device 100 is less than 15%. Optionally, the resonance frequency F0 ranges from 100 Hz to 300 Hz, the total harmonic distortion THD of the sound generating device 100 is less than 10%.

In the above frequency band range, the total harmonic distortion THD of the sound generating device 100 is limited to be less than 10%, which can ensure that the sound distortion degree of the sound generating device 100 is small, and the user can obtain a better listening effect. Optionally, the resonance frequency F0 is 200 Hz, the total harmonic distortion THD of the sound generating device 100 is less than 2.5%. That is, when the frequency is 200 Hz, the total harmonic distortion THD of the sound generating device 100 is limited to be less than 2.5%. Optionally, the resonance frequency F0 is 300 Hz, the total harmonic distortion THD of the sound generating device 100 is less than 2%. That is, when the frequency is 300 Hz, the total harmonic distortion THD of the sound generating device 100 is limited to less than 2%.

The sound generating device 100 of the present disclosure is connected to an end of the basket 5 through the magnetic circuit system 6, and the diaphragm 4 is connected to the other end of the basket 5, so that the voice coil 1 is formed with the hollow 11, and the conductive connecting member 2 is arranged on the outer surface 12 of the voice coil 1, and the conductive support plate 3 is arranged as a planar support member, so that the fixing member 31 of the conductive support plate 3 is connected to the voice coil 1 through the conductive connecting member 2, and the elastic arm 32 extends along the circumferential direction of the voice coil 1, and is connected to the basket 5 through the welding portion 33, thereby facilitating the conductive connection to the voice coil 1 through the conductive support plate 3 and the voice coil 1, so as to transmit an electrical signal to the voice coil 1. Meanwhile, the planar support member not only provides a centering function for the voice coil 1, but also transmit an electrical signal to the voice coil 1, and the planar support member not only eliminates the traditional manner of connection to the voice coil by using the elastic wave centering member and the tinsel wire, but also effectively simplifies the processing steps of the sound generating device 100, reduces the production costs, and the planar support member can obtain a smaller Kms, so that compared with the related art, the sound generating device 100 can obtain a good acoustic performance, and effectively extend the service life of the sound generating device 100. Further, by displacing the vibration of the voice coil 1 by 1 mm to 15 mm and setting the mechanical stiffness Kms of the conductive support plate 3 in a range from 0.1 to 1 N/mm, the resonant frequency F0 of the sound generating device 100 can be set in a range from 30 Hz to 300 Hz, resulting in a total harmonic distortion THD of the sound generating device 100 of less than 15% and achieving good acoustic performance.

In an embodiment, the diaphragm 4, the basket 5, and the magnetic circuit system 6 enclose a vibration space 7, and the conductive support plate 3 is positioned in the vibration space 7. The magnetic circuit system 6 is further provided with an avoidance notch 621 at a position corresponding to the conductive connecting member 2, the avoidance notch 621 communicates the vibration space 7 and the magnetic gap 61, and the avoidance notch 621 is configured to prevent the conductive connecting member 2 and the conductive support plate 3 from interfering with the vibration displacement of the voice coil 1 within the magnetic gap 61.

In this embodiment, as shown in FIGS. 1 to 8 and 22, the basket 5 may be of a cylindrical shape with an end open and the other end closed. The basket 5 may also be of a cylindrical shape with two ends open, but the present disclosure is not limited to it. In this embodiment, the basket 5 may be a cylindrical structure with an opening at one end, that is, the basket 5 has a cavity 51, one end of the basket 5 away from the opening is a closed end, the closed end is provided with a mounting hole communicating with the cavity 51, and the magnetic circuit system 6 is connected to the basket 5 and located at the mounting hole. The diaphragm 4 is connected to the other end of the basket 5 and covers the opening, and the diaphragm 4 is opposite to and spaced apart from the magnetic circuit system 6, so that the diaphragm 4, the basket 5 and the magnetic circuit system 6 enclose the vibration space 7.

It should be understood that the voice coil 1, the conductive connecting member 2, and the conductive support plate 3 are all located in the vibration space 7. The magnetic circuit system 6 has a magnetic gap 61 that communicates with the vibration space 7, one end of the voice coil 1 is connected to the diaphragm 4, and the other end of the voice coil 1 is suspended in the magnetic gap 61. In this way, the pad portion 33 of the conductive support plate 3 is connected to the basket 5 to implement connection to the external pad of the sound generating device 100, and the fixing member 31 of the conductive support plate 3 is connected to the voice coil 1 through the conductive connecting member 2, so that a current of an external circuit can be introduced into the voice coil 1 through the conductive support plate 3, so that the voice coil 1 introduces an electrical signal into a magnetic field generated by the magnetic circuit system 6, and converts the electrical signal into mechanical motion for cutting a magnetic induction line, so that the voice coil 1 drives the diaphragm 4 to vibrate and produce sound, and converts mechanical energy into a sound signal.

Optionally, the vibration displacement of the voice coil 1 ranges from 1 mm to 15 mm. That is, the vibration displacement of the voice coil 1 within the magnetic gap 61 ranges from 1 mm to 15 mm. In this embodiment, the vibration displacement of the voice coil 1 may be 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, etc., but the present disclosure is not limited to it.

In this embodiment, the basket 5 is optionally cylindrical, and the diaphragm 4 covers one end of the basket 5. Optionally, the diaphragm 4 has a diameter of 40 mm to 75 mm. It can be understood that the diameter of the diaphragm 4 may be 40 mm, 45 mm, 50 mm, 55 mm, 60 mm, 65 mm, 70 mm, 75 mm, etc., but the present disclosure is not limited to it.

In order to prevent the conductive connecting member 2 and the conductive support plate 3 from interfering with the vibration displacement of the voice coil 1 within the magnetic gap 61, as shown in FIGS. 2, 4, 5, 6 and 9, the magnetic circuit system 6 is further provided with an avoidance notch 621 at a position corresponding to the conductive connecting member 2, The avoidance notch 621 communicates the vibration space 7 and the magnetic gap 61. In an embodiment, a part of the conductive connecting member 2 is positioned in the avoidance notch 621 and is connected to the fixing member 31.

In an embodiment, the magnetic circuit system 6 includes a U-shaped iron 62 and a central magnetic circuit part 63, the U-shaped iron 62 is provided with a receiving groove 622, and the central magnetic circuit part 63 is positioned in the receiving groove 622 and is spaced apart from a side wall of the receiving groove 622 and a magnetic gap 61 is formed therebetween, and the U-shaped iron 62 is provided with an avoidance notch 621 on the side wall.

In the present embodiment, as shown in FIGS. 2, 3, 6, 7 and 9, the U-shaped iron 62 is optionally U-shaped or bowl-shaped, etc., but the present disclosure is not limited to it. The U-shaped iron 62 is formed with a receiving groove 622, the central magnetic circuit part 63 is disposed in the receiving groove 622, and the central magnetic circuit part 63 is spaced apart from the side wall of the receiving groove 622 to form a magnetic gap 61. Optionally, the central magnetic circuit part 63 includes at least one central magnet and at least one central washer that are stacked. Of course, in other embodiments, the central magnetic circuit part 63 includes a plurality of central magnets and a plurality of central washers that are stacked, and the central magnets and the central washers are alternately arranged, but the present disclosure is not limited to it.

It should be understood that the side wall of the U-shaped iron 62 is provided with an avoidance notch 621, and the avoidance notch 621 communicates with the receiving groove 622. In order to prevent the conductive connecting member 2 and the fixing member 31 of the conductive support plate 3 from affecting the magnetic flux utilization rate of the voice coil 1 within the magnetic gap 61, a part of the conductive connecting member 2 is positioned in the avoidance notch 621 and is connected to the fixing member 31.

In an embodiment, a plurality of conductive connecting members 2 are provided, the plurality of conductive connecting members 2 are spaced apart on the outer surface 12 and distributed at intervals along the circumferential direction of the voice coil 1. The magnetic circuit system 6 is provided with an avoidance notch 621 corresponding to each conductive connecting member 2. A plurality of conductive support plates 3 are provided, and the fixing member 31 of each conductive support plate 3 is connected to one conductive connecting member 2.

In this embodiment, as shown in FIGS. 2, 6, and 9 to 11, a plurality of conductive connecting members 2 and a plurality of conductive support plates 3 are disposed, so that the plurality of conductive connecting members 2 are spaced apart on the outer surface 12 and distributed at intervals along the circumferential direction of the voice coil 1. The fixing member 31 of each conductive support plate 3 is connected to one conductive connecting member 2, so that the plurality of conductive support plate 3 can be conveniently connected to the voice coil 1324, and the plurality of conductive support plate 3 can also be used to improve the centering function for the voice coil 1, thereby effectively avoiding the polarization phenomenon in the vibration process of the voice coil 1 driving the diaphragm 4.

It should be understood that the U-shaped iron 62 of the magnetic circuit system 6 is provided with a plurality of avoidance notches 621 corresponding to the plurality of conductive connecting members 2, and the side wall of the basket 5 is provided with a plurality of avoidance holes 53 and a plurality of welding portions 33 corresponding to the plurality of conductive support plate 3. Optionally, an angle the avoidance notch 621 ranges from 15° to 27°.

In an embodiment, as shown in FIGS. 2, 6, and 9 to 11, the plurality of elastic arms 32 of the plurality of conductive support plate 3 extend in the same circumferential direction of the voice coil 1. It can be understood that such an arrangement not only improves the balance effect of the voice coil 1, but also helps prevent the elastic arm 32 from interfering with other conductive support plate 3.

In this embodiment, as shown in FIGS. 2, 6, and 9 to 11, the elastic arm 32 of the conductive support plate 3 extends around the outer peripheral side of the U-shaped iron 62. In this way, a length of the elastic arm 32 can be increased, deformation performance of the elastic arm 32 can be improved, and a balance effect of the voice coil 1 can be improved. Meanwhile, the plurality of conductive support plate 3 is also facilitated.

Optionally, the voice coil 1 has a cylindrical shape, and a diameter of the voice coil 1 is 14 mm to 28 mm. It should be noted that when the sound generating device 100 has a large-horn loudspeaker structure, the voice coil 1 has a cylindrical structure, and a diameter of the voice coil 1 is in a relatively wide range. Optionally, the diameter of the voice coil 1 may be 14 mm, 16 mm, 18 mm, 20 mm, 22 mm, 25 mm, 28 mm, etc., but the present disclosure is not limited to it.

In an embodiment, the voice coil 1 has a cylindrical shape, four conductive connecting members 2 and four conductive support plate 3 are provided, and the four conductive connecting members 2 are spaced apart and evenly distributed along the circumferential direction of the voice coil 1, such that an included angle formed by lines connecting any two adjacent conductive connecting members 2 and a center of the voice coil 1 is 90°.

It should be understood that, as shown in FIGS. 2, 3, 4, 9, and 10, the four fixing members 31 of the four conductive support plate 3 are respectively connected to the four conductive connecting members 2, and the four elastic arms 32 of the four conductive support plate 3 are disposed around the voice coil 1 along the circumferential direction. In this embodiment, the elastic arm 32 is optionally positioned in an arc shape, and an arc bending direction of the elastic arm 32 correspond to an arc bending direction of the outer surface 12 of the voice coil 1.

In this embodiment, optionally, the four conductive connecting members 2 disposed on the outer surface 12 of the voice coil 1 are uniformly disposed along the circumferential direction of the voice coil 1. Optionally, an included angle formed by lines connecting any two adjacent conductive connecting members 2 and the center of the voice coil 1 is 90°.

In another embodiment, three conductive connecting members 2 and the three conductive connecting members 2 are provided to be spaced apart and evenly distributed along the circumferential direction of the voice coil 1, such that an included angle formed by lines connecting any two adjacent conductive connecting members 2 and the center of the voice coil 1 is 120°.

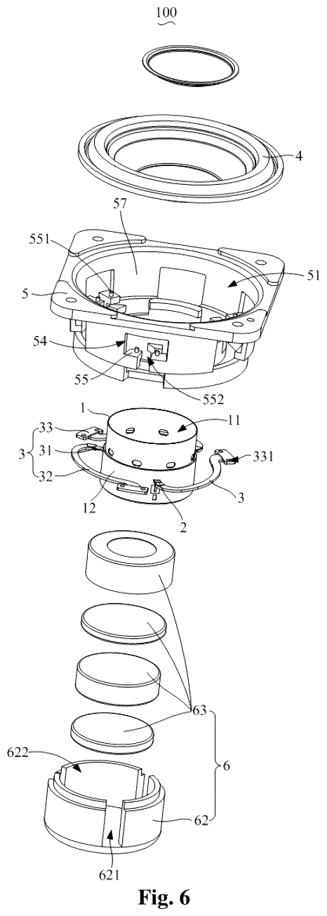

It should be understood that, as shown in FIGS. 6, 8, and 11, the three fixing members 31 of the three conductive support plate 3 are respectively connected to the three conductive connecting members 2, and the three elastic arms 32 of the three conductive support plate 3 are disposed around the voice coil 1 along the circumferential direction. In this embodiment, the elastic arm 32 is optionally positioned in an arc shape, and an arc bending direction of the elastic arm 32 correspond to an arc bending direction of the outer surface 12 of the voice coil 1.

In this embodiment, the three conductive connecting members 2 disposed on the outer surface 12 of the voice coil 1 are optionally uniformly disposed along the circumferential direction of the voice coil 1. Optionally, an included angle formed by lines connecting any two adjacent conductive connecting members 2 and the center of the voice coil 1 is 120°.

In an embodiment, the basket 5 is provided with an outer pad 52, the welding portion 33 is connected to the outer pad 52, the basket 5 is provided with an avoidance hole 53 corresponding to the outer pad 52, and the welding portion 33 passes through the avoidance hole 53 and is connected to the outer pad 52.

In this embodiment, as shown in FIGS. 1, 2, 4, 8, 9, 10, and 22, the basket 5 has a cavity 51, the basket 5 is further provided with an external pad 52, and the welding portion 33 is connected to the external pad 52. It can be understood that the diaphragm 4 is connected to one end of the basket 5, and the magnetic circuit system 6 is connected to the other end of the basket 5, so that the diaphragm 4, the basket 5 and the magnetic circuit system 6 enclose a vibration space 7. The magnetic circuit system 6 has a magnetic gap 61, one end of the voice coil 1 is connected to the diaphragm 4, and the other end of the voice coil 1 is suspended in the magnetic gap 61. The conductive support plate 3 is positioned in the vibration space 7, the magnetic circuit system 6 is further provided with an avoidance notch 621 at a position corresponding to the conductive connecting member 2, the avoidance notch 621 communicates the vibration space 7 with the magnetic gap 61, and a part of the conductive connecting member 2 is positioned in the avoidance notch 621 and is connected to the fixing member 31.

It should be understood that the avoidance hole 53 is disposed in the basket 5, to facilitate connection and conduction between the external pad 52 and an external circuit. Optionally, the welding portion 33 passes through the avoidance hole 53 to be connected to the outer pad 52. In this embodiment, the basket 5 is provided with an external pad 52, and the external pad 52 is configured to be connected to an external circuit, so that the pad portion 33 of the conductive support plate 3 is connected to the external pad 52, and the fixing member 31 of the conductive support plate 3 is connected to the voice coil 1 through the conductive connecting member 2, so that a current of the external circuit can be introduced into the voice coil 1 through the conductive support plate 3, so that the voice coil 1 introduces an electrical signal into a magnetic field generated by the magnetic circuit system 6, and converts the electrical signal into mechanical motion of cutting a magnetic induction line, so that the voice coil 1 drives the diaphragm 4 to vibrate and produce sound, and converts mechanical energy into a sound signal.

In an embodiment, the sound generating device 100 includes a basket 5, a voice coil 1, a conductive connecting member 2 and a conductive support plate 3, the basket 5 is provided with an outer pad 52, the voice coil 1 is formed with a hollow 11, the voice coil 1 has an outer surface 12 facing away from the hollow 11, the conductive connecting member 2 is disposed on the outer surface 12, the conductive support plate 3 is a planar support member for transmitting an electrical signal to the voice coil 1, the conductive support plate 3 includes a fixing member 31, an elastic arm 32 and a welding portion 33 that are connected. The fixing member 31 is connected to the voice coil 1 through the conductive connecting member 2, the elastic arm 32 extends along a circumferential direction of the voice coil 1, and the welding portion 33 is connected to the outer pad 52.

In an embodiment, the basket 5 includes a bottom wall 56 and a side wall 57. In this embodiment, as shown in FIGS. 1 to 8 and 22, the side wall 57 of the basket 5 is disposed on a periphery of the bottom wall 56, so that the side wall 57 and the bottom wall 56 enclose a cavity 51 with an opening at one end, the bottom wall 56 is provided with a mounting hole, and an opening at one end of the U-shaped iron 62 of the magnetic circuit system 6 passes through the mounting hole, to allow an outer side wall of the U-shaped iron 62 to be welded or adhesively connected to a hole wall of the mounting hole, but the present disclosure is not limited to it.

It can be understood that, in order to further improve the connection stability between the U-shaped iron 62 and the basket 5 and position the U-shaped iron 62, the bottom of the basket 5 is provided with a positioning portion protruding toward one side of the cavity 51, and the positioning portion is arranged around the mounting hole, so that the positioning portion can be connected to the outer side wall of the U-shaped iron 62 to increase the connection area and improve the connection stability. Meanwhile, the positioning portion is between adjacent avoidance holes 53, thereby positioning the U-shaped iron 62.

Optionally, a plurality of conductive connecting members 2 are provided, the plurality of conductive connecting members 2 are spaced apart on the outer surface 12 and distributed at intervals along the circumferential direction of the voice coil 1. The magnetic circuit system 6 is provided with an avoidance notch 621 corresponding to each conductive connecting member 2. A plurality of conductive support plates 3 are provided, and the fixing member 31 of each conductive support plate 3 is connected to one conductive connecting member 2. The basket 5 is provided with a plurality of outer pads 52, the basket 5 is provided with an avoidance hole 53 for each outer pad 52, and each welding portion 33 is connected to an outer pad 52 through the avoidance hole 53.

In this embodiment, each avoidance hole 53 corresponds to one avoidance notch 621 and is positioned in the same radial direction of the voice coil 1. Optionally, the elastic arm 32 of one conductive support plate 3 extends from the fixing member 31 to the fixing member 31 of one conductive support plate 3 along the circumferential direction of the voice coil 1, so that the welding portion 33 of one conductive support plate 3 corresponds to and is spaced apart from the fixing member 31 of another adjacent conductive support plate 3.

In another embodiment, the basket 5 has an opening 54 and a support portion 55 located in the opening 54, and the welding portion 33 is fixed to the support portion 55 and connected to an external circuit.

In this embodiment, as shown in FIGS. 1 to 8 and 22, the basket 5 has a bottom wall 56 and a side wall 57 arranged at a periphery of the bottom wall 56, and the side wall 57 and the bottom wall 56 of the basket 5 enclose a cavity 51 with an opening at one end. It can be understood that, in order to facilitate the installation of the magnetic circuit system 6, the bottom wall 56 of the basket 5 is provided with a mounting hole, and the open end of the U-shaped iron 62 of the magnetic circuit system 6 passes through the mounting hole, so that the outer side wall of the U-shaped iron 62 is welded or adhesively connected to the hole wall of the mounting hole, but the present disclosure is not limited to it.

It should be understood that the opening 54 is optionally disposed on the side wall 57 of the basket 5. In this embodiment, the opening 54 is a through hole or an opening or a notch structure penetrating the side wall 57 of the basket 5, but the present disclosure is not limited to it. By providing the support portion 55 in the opening 54, it is convenient to mount and fix the welding portion 33 of the conductive support plate 3 by using the support portion 55, so that the welding portion 33 is disposed on the support portion 55, and the pad of the welding portion 33 is exposed from the opening 54, which facilitates the connection of the welding portion 33 of the conductive support plate 3 to the external circuit, thereby smoothly introducing the current of the external circuit into the voice coil 1. Optionally, the support portion 55 may be a boss, a step, a ridge structure or the like protruding from the inner wall of the opening 54, but the present disclosure is not limited to it.

In an embodiment, as shown in FIGS. 5 to 8 and 22, the opening 54 is disposed on the side wall 57 and extends to the bottom wall 56. In this embodiment, as shown in FIGS. 5 to 8 and 22, the support portion 55 is formed by an inner wall of the opening 54 located on the side wall 57 protruding toward the cavity 51 of the basket 1 or toward a center of the opening 54, but the present disclosure is not limited to it.

Optionally, two support portions 55 are provided to be spaced apart from each other, and a welding groove 552 is formed between the two support portions 55 for welding the welding portion 33 and an external circuit. In this embodiment, the two support portions 55 are opposite to each other and spaced apart from each other. A welding groove 552 is formed between the two support portions 55, and the pad of the welding portion 33 is exposed through the welding groove 552, which facilitates welding of the welding portion 33 and an external circuit. It can be understood that the two support portions 55 are both formed by an inner wall of the opening 54 located on two opposite sides of the side wall 57 protruding toward the cavity 51 of the basket 1 or toward the center of the window 54, but the present disclosure is not limited to it.

In an embodiment, the basket 5 has an opening 54 and a support portion 55 located in the opening 54, and the welding portion 33 is fixed to the support portion 55 and connected to an external circuit. Here, the welding portion 33 has a positioning hole 331, and the support portion 55 is provided with a positioning pin 551 to be coupled with the positioning hole 331.

In this embodiment, as shown in FIGS. 5 to 7 and 22, the positioning pin 551 is disposed on the support portion 55, and the positioning hole 331 is disposed on the welding portion 33 of the conductive support plate 3, so that the welding portion 33 is connected and fixed to the support portion 55 through cooperation between the positioning hole 331 and the positioning pin 551, which not only improves mounting stability, but can also be used for positioning and mounting.

In an embodiment, a plurality of conductive support plates 3 are provided, each elastic arm 32 includes a first arc segment 321, a second arc segment 322 and a third arc segment 323 connected in sequence, the first arc segment 321 is connected to the fixing member 31, the third arc segment 323 is connected to the welding portion 33, and the second arc segment 322 extends from the first arc segment 321 to the third arc segment 323 along the circumferential direction of the voice coil 1, such that the third arc segment 323 and the welding portion 33 of one conductive support plate 3 correspond to and are spaced apart from the fixing member 31 of the other conductive support plate 3.

In this embodiment, as shown in FIGS. 2, 6, 9 to 11, and 14 to 17, the first arc segment 321, the second arc segment 322, and the third arc segment 323 of the elastic arm 32 may be an integrally formed structure. The first arc segment 321 of the elastic arm 32 is connected to the fixing member 31, and is configured to guide the elastic arm 32 from the fixing member 31 adjacent to the outer surface 12 of the voice coil 1 toward an end away from the outer surface 12 of the voice coil 1. That is, the first arc segment 321 is guided from the fixing member 31 perpendicular to the outer surface 12 of the voice coil 1 to be away from the outer surface 12, and is approximately parallel to the outer surface 12, and the first arc segment 321 is bent toward the second arc segment 322.

It should be understood that an extension direction of the second arc segment 322 approximately consistent with a peripheral direction of the outer surface 12 of the voice coil 1. Optionally, the third arc segment 323 of one elastic arm 32 corresponds to and is spaced apart from the fixing member 31 of the other conductive support plate 3 and the first arc segment 321. That is, the elastic arm 32 of one conductive support plate 3 extends from the fixing member 31 to the fixing member 31 of another conductive support plate 3.

It should be noted that an arc length of the second arc segment 322 is greater than an arc length of the first arc segment 321, so that the stress of the first arc segment 321 and the fixing member 31 can be effectively dispersed by using the second arc segment 322, and the deformation capability of the second arc segment 322 is effectively improved. The arc length of the second arc segment 322 is greater than an arc length of the third arc segment 323, so that the stress of the third arc segment 323 and the welding portion 33 can be effectively dispersed by the second arc segment 322, and the deformation capability of the second arc segment 322 is effectively improved.

In this embodiment, the conductive support plate 3 further includes a welding portion 33, and the welding portion 33 is connected to an end of the third arc segment 323 away from the second arc segment 322. It should be understood that the conductive support plate 3 may be welded to the outer pad 52 by using the welding portion 33, so that a current of an external circuit is guided to the voice coil 1 through the conductive support plate 3 and the conductive connecting member 2.

Optionally, curvature centers of the first arc segment 321 and the second arc segment 322 and a curvature center of the third arc segment 323 are located on opposite sides of the second arc segment 322. In this way, it is convenient for the conductive support plate 3 to be connected to the conductive connecting member 2 through the fixing member 31, and to be welded to the outer pad 52 through the welding portion 33.

In an embodiment, an arc angle of the first arc segment 321 is greater than 90°, and an arc angle of the second arc segment 322 is less than 90°. Such an arrangement can effectively disperse the stress of the first arc segment 321 by using the second arc segment 322, and prevent the first arc segment 321 from breaking.

Optionally, a minimum gap distance between the third arc segment 323 and the fixing member 31 of another conductive support plate 3 is greater than 1 mm. Such an arrangement not only prevents the third arc segment 323 of one conductive support plate 3 from interfering with the fixing member 31 and the first arc segment 321 of another conductive support plate 3, but also maximize the usage of the limited space, and prevent the fixing member 31 of the conductive support plate 3 and the first arc segment 321 from being broken due to stress concentration.

In this embodiment, a width of the fixing member 31 of the conductive support plate 3 may be 1 mm to 3 mm. Optionally, the width of the fixing member 31 is 1 mm, 1.5 mm, 2 mm, 2.5 mm, 3 mm, etc., but the present disclosure is not limited to it. It can be understood that by setting the width of the fixing member 31 ranges from 1 mm to 3 mm, the connection stability between the conductive support plate 3 and the conductive connecting member 2 can be ensured, and the conductivity can be ensured.

Optionally, the elastic arm 32 of the conductive support plate 3 has a width of 1 mm to 3 mm. Optionally, the width of the elastic arm 32 is 1 mm, 1.5 mm, 2 mm, 2.5 mm, 3 mm, etc., but the present disclosure is not limited to it. In this embodiment, the width of the elastic arm 32 may be the same as the width of the fixing member 31. Alternatively, the width of the elastic arm 32 is different from the width of the fixing member 31.

Optionally, the width of the elastic arm 32 is less than the width of the fixing member 31, so that the elastic arm 32 can be used to disperse and reduce the stress concentration of the fixing member 31, and the deformation capability of the elastic arm 32 can be improved.

In this embodiment, the first arc segment 321, the second arc segment 322 and the third arc segment 323 of the elastic arm 32 may be of equal width, that is, the width of the first arc segment 321, the width of the second arc segment 322 and the width of the third arc segment 323 are the same. Of course, the first arc segment 321, the second arc segment 322 and the third arc segment 323 of the elastic arm 32 may also be unequal in width.

In an embodiment, the width of the first arc segment 321 gradually decreases from the fixing member 31 to the second arc segment 322, the width of the second arc segment 322 gradually decreases from the first arc segment 321 to the third arc segment 323, and the width of the third arc segment 323 gradually increases from the second arc segment 322 toward an end away from the second arc segment 322, that is, the width of the third arc segment 323 gradually increases from the second arc segment 322 to the welding portion 33.

In another embodiment, the width of the first arc segment 321 is constant from the fixing member 31 to the second arc segment 322, the width of the second arc segment 322 gradually decreases from the first arc segment 321 to the third arc segment 323, and the width of the third arc segment 323 gradually increases from the second arc segment 322 toward an end away from the second arc segment 322, that is, the width of the third arc segment 323 gradually increases from the second arc segment 322 to the welding portion 33.

In still another embodiment, the width of the first arc segment 321 is constant from the fixing member 31 to the second arc segment 322, the width of the second arc segment 322 first decreases and then increases from the first arc segment 321 to the third arc segment 323, and the width of the third arc segment 323 gradually increases from the second arc segment 322 toward an end away from the second arc segment 322, that is, the width of the third arc segment 323 gradually increases from the second arc segment 322 to the welding portion 33.

It can be understood that the fixing member 31, the elastic arm 32 and the welding portion 33 of the conductive support plate 3 are located in the same plane, and the width of the fixing member 31 and the width of the elastic arm 32 both refer to the width in the plane perpendicular to the extending direction thereof.

In this embodiment, the length of the second arc segment 322 of the conductive support plate 3 is related to the mechanical stiffness Kms of the conductive support plate 3, when the included angle formed by the connection between the two ends of the second arc segment 322 and the center of the voice coil 1 is 15°, it is measured that the mechanical stiffness of the conductive support plate 3 is 1.02 N/mm, and the elastic force variation of the conductive support plate 3 is 23.5% when the elastic arm 32 is elastically deformed by 2 mm. The included angle is increased to 25°, the mechanical stiffness of the obtained conductive support plate 3 ranges from 0.565 N/mm, and the elastic force variation of the conductive support plate 3 is 7% when the elastic deformation of the elastic arm 32 is 2 mm. The included angle is continuously increased to 35°, and it is measured that the mechanical stiffness of the conductive support plate 3 ranges from 0.325 N/mm, and the elastic force variation of the conductive support plate 3 is 2% when the elastic deformation of the elastic arm 32 is 2 mm.

It can be understood that, when other parameters are the same, the larger the angle value of the included angle is, the lower the mechanical stiffness Kms value is, and the better the linear performance of the conductive support plate 3 is. As the angle of the acute angle increases, the mechanical stiffness of the conductive support plate 3 decreases significantly, and the resonance frequency F0 of the sound generating device 100 correspondingly using the conductive support plate 3 as the centering damper decreases, so that the sound generating device 100 can obtain higher bass sensitivity, which is advantageous in improving the acoustic performance of the sound generating device 100.

In this embodiment, the mechanical stiffness Kms of the conductive support plate ranges from 0.1 N/mm to 1 N/mm. Specifically, the mechanical stiffness Kms of the conductive support plate 3 may be 0.1 N/mm, 0.2 N/mm, 0.3 N/mm, 0.4 N/mm, 0.5 N/mm, 0.6 N/mm, 0.7 N/mm, 0.8 N/mm, 0.9 N/mm, 1 N/mm, or the like. Within this range, the linearity of the conductive support plate 3 is good, which ensures that the conductive support plate 3 not only provides a sufficient buffering effect for the voice coil 1 of the sound generating device 100, but also will not be damaged due to plastic deformation when the sound generating device 100 vibrates with a large displacement.

Optionally, the thickness of the conductive support plate 3 ranges from 0.3 mm to 1 mm. The thickness of the conductive support plate 3 may be 0.3 mm, 0.5 mm, 0.8 mm, 1 mm, etc., and this arrangement can ensure that the conductive support plate 3 has a certain hardness and ensure the centering capability of the conductive support plate 3 on the voice coil 1. It should be noted that the thickness of the conductive support plate 3 should be the thickness of most of the area of the conductive support plate 3, and should not be the thickness of the thinned area at both ends of the conductive support plate 3 for welding. It can be understood that the thickness of the conductive support plate 3 applied to the large-horn loudspeaker is greater than the thickness of the conductive support plate 3 in the micro loudspeaker.

In this embodiment, the thickness of the conductive support plate 3 is related to the mechanical stiffness value of the conductive support plate 3; when the thickness of the conductive support plate 3 is 0.3 mm, the mechanical stiffness Kms value of the conductive support plate 3 is 0.565 N/mm, and the elastic force variation of the elastic arm 32 of the conductive support plate 3 is 7% when the elastic deformation of 2 mm occurs; when the thickness of the conductive support plate 3 is 0.33 mm, the mechanical stiffness Kms value of the conductive support plate 3 is 0.81 N/mm, and the elastic force variation of the elastic arm 32 of the conductive support plate 3 is 6.1% when the elastic deformation of 2 mm occurs; when the thickness of the conductive support plate 3 is 0.35 mm, the mechanical stiffness Kms value of the conductive support plate 3 is 1.01 N/mm, and the elastic force variation of the elastic arm 32 of the conductive support plate 3 is 6.1% when the elastic deformation of 2 mm occurs.

It can be understood that when other parameters are the same, the greater the thickness of the conductive support plate 3, the corresponding mechanical stiffness Kms increases, and the linear performance of the conductive support plate 3 deteriorates, but the linear performance change is not obvious. Considering the overall strength of the conductive support plate 3, the thickness of the conductive support plate 3 cannot be configured to be too small, and the conductive support plate 3 with a too small thickness will not meet the strength requirement, therefore, when the wire diameter of the thickness of the conductive support plate 3 is set to 0.3 mm to 1.0 mm, the mechanical stiffness and linear performance of the conductive support plate 3 can be ensured while the strength requirement is ensured.

In an embodiment, the length of the conductive support plate 3 is ≥30 mm.

It should be noted that the hardness and centering capability of the existing plane support member used in the micro loudspeaker cannot meet the requirements of the large-horn loudspeaker, so the centering damper in the large-horn loudspeaker generally adopts an elastic centering damper. The present application can finally achieve a good use effect by improving and verifying the material and shape of the conductive support plate 3.

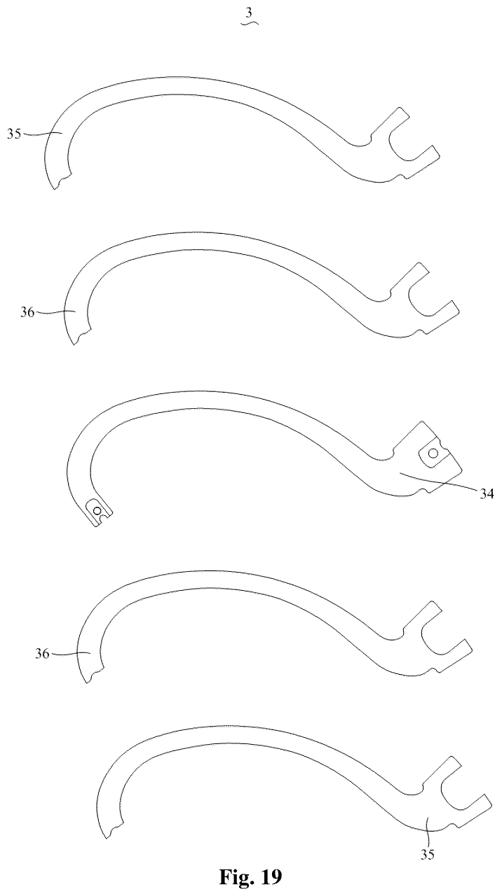

In an embodiment, in order to enable the planar conductive support plate 3 to meet hardness requirements and centering requirements, as shown in FIGS. 18 and 19, the conductive support plate 3 includes a FPCB layer 34 and a reinforcing layer 35, the FPCB layer 34 has a first surface and a second surface facing opposite to each other, and the reinforcing layer 35 is adhered to the first surface and/or the second surface through an adhesive layer 36.

As shown in FIG. 18, the reinforcing layer 35 includes one layer, that is, the reinforcing layer 35 is adhered to the first surface or the second surface of the FPCB layer 34 through the adhesive layer 36. As shown in FIG. 19, the reinforcing layer 35 includes two layers, that is, the two reinforcing layers 35 are respectively adhered to the first surface and the second surface of the FPCB layer 34 by using the adhesive layer 36. Optionally, the reinforcing layer 35 is made of at least one of PI, PEN, PET, and PEI.

It should be understood that, in the foregoing embodiment, a modulus of the copper layer 342 ranges from 0.7×10¹¹ Pa to 3×10¹¹ Pa, and modulus ranges of the cover film layer 343 and the reinforcing layer 35 ranges from 1000 MPa to 7000 MPa. The conductive support plate 3 within this modulus range has good compliance and deformation resistance, and meets the centering requirements of the sound generating device 100. Optionally, the mechanical stiffness Kms of the conductive support plate 3 ranges from 0.1 N/mm to 1 N/mm.

Optionally, the adhesive layer 36 is thermosetting adhesive or acrylic adhesive. It can be understood that, in the case of the adhesive layer 36 for bonding the FPCB layer 34 and the reinforcing layer 35, the thermosetting adhesive can improve the bonding force between the FPCB layer 34 and the reinforcing layer 35. The acrylic adhesive has a certain damping, and the energy of the resonance of the conductive support plate 3 is absorbed by the acrylic adhesive to reduce the resonance of the voice coil. The reinforcing layer 35 and the FPCB layer 34 have a torque, and the conductive support plate 3 has a large elongation at break and is not prone to cracking. The acrylic adhesive may be an acrylic adhesive layer, but the present disclosure is not limited to it.

In this embodiment, the thickness of the reinforcing layer 35 may be 0.1 mm to 0.5 mm. The thickness of the reinforcing layer 35 may be 0.1 mm, 0.15 mm, 0.2 mm, 0.3 mm, 0.4 mm, or 0.5 mm. This can ensure the strength of the conductive support plate 3, enhance the centering ability of the conductive support plate 3, and reduce the product resonance. The thickness of the adhesive layer 36 may be 0.015 mm to 0.1 mm. Optionally, the thickness of the adhesive layer 36 may be 0.015 mm, 0.03 mm, 0.05 mm, 0.08 mm, 0.1 mm, etc., but the present disclosure is not limited to it. In actual implementation, the hardness and centering capability of the conductive support plate 3 may be adjusted by adjusting the thickness of the reinforcing layer 35, so that the number of the conductive support plate 3 used may be further adjusted to meet various use requirements, for example, reducing the number of the conductive support plate 3 used and saving costs. The thickness of the reinforcing layer 35 can be adjusted by thickening or thinning the single-layer reinforcing layer, or increasing or decreasing the number of layers of the reinforcing layer, but the overall thickness of the reinforcing layer 35 is still within the above range. Correspondingly, the thickness of the adhesive layer 36 may also be adjusted to meet use requirements.

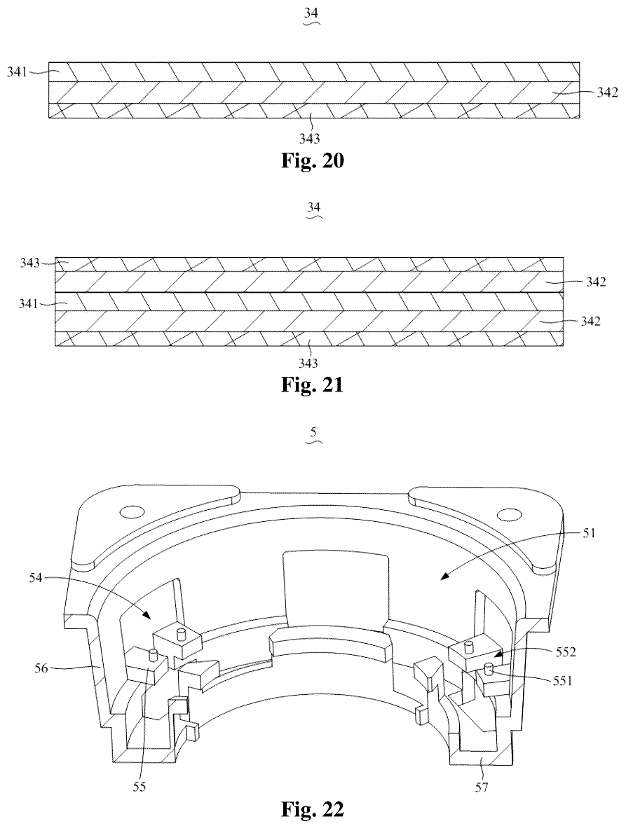

In an embodiment, as shown in FIG. 20, the FPCB layer 34 includes a substrate layer 341, a copper layer 342, and a cover film layer 343 that are sequentially stacked, a side of the substrate layer 341 facing away from the copper layer 342 forms a first surface, and a side of the cover film layer 343 facing away from the copper layer 342 forms a second surface. It can be understood that the FPCB layer 34 has a single copper layer 342.

In another embodiment, as shown in FIG. 21, the FPCB layer 34 includes a substrate layer 341, two copper layers 342 and two cover film layers 343, the substrate layer 341 is sandwiched between the two copper layers 342, each cover film layer 343 is disposed on a side of each copper layer 342 facing away from the substrate layer 341, and a side of the cover film layer 343 facing away from the copper layer 342 forms the first surface or the second surface. It can be understood that the FPCB layer 34 has a double-layer copper layer 342. The double copper layer 342 can reduce the resistance of the FPCB layer 34 and improve the sensitivity of the sound generating device 100. Alternatively, when one copper layer 342 is disconnected, another copper layer 342 may provide a current path, to improve use reliability of the FPCB layer 34 and the conductive support plate 3.

It can be understood that in order to reduce the product cost or improve the overall performance of the conductive support plate 3, for the FPCB layer 34 having the double-layer copper layer 342, the cover film layer 343 on one side may be removed and replaced with the reinforcing layer 35. Such arrangement not only increases the strength of the conductive support plate 3, enhance the centering ability of the conductive support plate 3, reduce the product resonance, but also reduce the cost. Of course, the reinforcing layer 35 may also be directly adhered to the side cover film layer 343, but the present disclosure is not limited to it.

It should be noted that by reasonably determining the type of the material of the conductive support plate 3 and adjusting the performance of the conductive support plate 3, the conductive support plate 3 with good compliance and high fatigue strength can be obtained, so that the sound generating device 100 obtains a smaller resonance frequency F0 and a longer service life. In addition, the material of the conductive support plate 3 has good temperature and moisture resistance, and the manufactured conductive support plate 3 is used in extreme environments such as high temperature and high humidity, which has less influence on the acoustic performance and service life of the sound generating device 100. In addition, the conductive support plate 3 may be used to replace the tinsel wire in the sound generating device 100, to input an electrical signal into the voice coil 1. This arrangement can, on the one hand, reduce the production costs of the sound generating device 100, and on the other hand, solve the problem of the compliance of the tinsel wire in the existing sound generating device 100 under the trend of miniaturization in size, reduce the problem of poor listening caused by the compliance of the tinsel wire, and provide conditions for reducing the height of the sound generating device 100 product.

In an embodiment, the conductive connecting member 2 includes a first connecting portion 21 and a second connecting portion 22 disposed at an angle, the first connecting portion 21 is connected to the outer surface 12, and the second connecting portion 22 is connected to the fixing member 31.

In this embodiment, as shown in FIGS. 2 to 3 and 6 to 13, by setting the conductive connecting member 2 as the first connecting portion 21 and the second connecting portion 22 with an included angle, it is convenient for the conductive connecting member 2 to be connected to the outer surface 12 through the first connecting portion 21, so as to increase the contact area and improve the connection stability, and the conductive connecting member 2 on the outer surface 12 can be guided to be away from the outer surface 12 through the second connecting portion 22, so as to facilitate the connection with the conductive support plate 3. Optionally, the first connecting portion 21 and the second connecting portion 22 are provided perpendicular to each other.

Optionally, the width of the second connecting portion 22 is greater than the width of the first connecting portion 21. Such an arrangement can effectively increase the connection area between the second connection portion 22 and the conductive support plate 3 to improve the connection stability. Meanwhile, by reducing the width of the first connecting portion 21, the conductive connecting member 2 can be applied to the sound generating device 100, and the avoidance space of the magnetic circuit system 6 can be reduced, thereby increasing the magnetic flux utilization rate.

Optionally, the width of the first connecting portion 21 gradually decreases from an end adjacent to the second connecting portion 22 to an end away from the second connecting portion 22.

In this embodiment, the width of the second connecting portion 22 is the same as the width of the fixing member 31. In order to facilitate the connection between the conductive connecting member 2 and the outer surface 12 of the voice coil 1 and improve the connection stability, the outer surface 12 is provided with an inner pad 13 at a position corresponding to the conductive connecting member 2, and the first connecting portion 21 is welded to the inner pad 13.

Optionally, the conductive connecting member 2 is a metal sheet, so that the conductive support plate 3 is electrically connected to the voice coil 1 through the conductive connecting member 2. In this embodiment, the thickness of the conductive connecting member 2 may be 0.1 mm to 0.5 mm. Optionally, the thickness of the conductive connecting member 2 may be 0.1 mm, 0.2 mm, 0.3 mm, 0.4 mm, 0.5 mm, etc., but the present disclosure is not limited to it.

In an embodiment, as shown in FIGS. 2, 3, and 6 to 13, the second connecting portion 22 is connected to an end of the first connecting portion 21 close to the diaphragm 4, and the fixing member 31 is perpendicular to the outer surface 12 of the voice coil 1. In this embodiment, the outer surface 12 of the voice coil 1 is provided with an inner pad 13 at a position corresponding to the conductive connecting member 2, and the first connecting portion 21 is welded to the inner pad 13.

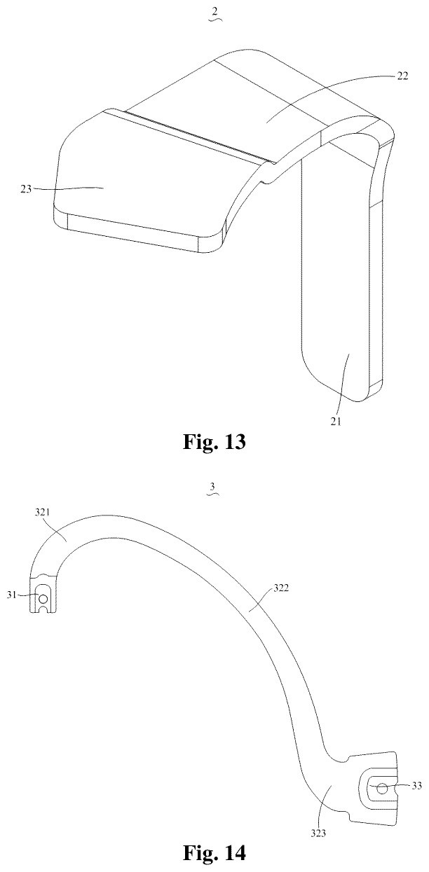

In an embodiment, as shown in FIGS. 12 and 13, an end of the second connecting portion 22 away from the first connecting portion 21 is bent in a direction away from the first connecting portion 21 to form a support bracket 23, and the support bracket 23 is configured to support an end of the elastic arm 32 adjacent to the fixing member 31. It can be understood that by providing the support bracket 23, a contact area between the conductive connecting member 2 and the conductive support plate 3 is increased to improve the connection stability.

In another embodiment, an end of the second connecting portion 22 away from the first connecting portion 21 is bent toward a side of the fixing member 31 to form a flange, the flange and the second connecting portion 22 enclose a mounting groove, and the fixing member 31 is accommodated and limited in the mounting groove. In this way, one end of the second connecting portion 22 away from the first connecting portion 21 is enclosed by the flange and the second connecting portion 22 to form a mounting groove with a semi-enclosed structure, and the fixing member 31 is accommodated and limited in the mounting groove, which can improve the connection stability between the conductive connecting member 2 and the conductive support plate 3.

In another embodiment, one end of the second connecting portion 22 away from the first connecting portion 21 is provided with a welding hole for welding the second connecting portion 22 and the fixing member 31. Such an arrangement can further enhance the connection stability between the conductive connecting member 2 and the conductive support plate 3.

The above description is only optional embodiments of the present disclosure, and is not intended to limit the patent scope of the disclosure, and under the concept of the present disclosure, any equivalent structural transformations made by using the content of the specification and drawings of the present disclosure, or direct/indirect applications in other related technical fields, are included in the patent protection scope of the present disclosure.

1. A sound generating device, comprising:
a basket;
a magnetic circuit system connected to an end of the basket and having a magnetic gap;
a voice coil formed with a hollow and having an outer surface facing away from a side of the hollow;
a diaphragm connected to the other end of the basket, an end of the voice coil being connected to the diaphragm, and the other end of the voice coil being suspended in the magnetic gap;
a conductive connecting member disposed on the outer surface; and
a conductive support plate, which is a planar support member, configured to transmit an electrical signal to the voice coil, the conductive support plate comprising a fixing member, an elastic arm, and a welding portion that are sequentially connected, the fixing member being connected to the voice coil through the conductive connecting member, the elastic arm extending along a circumferential direction of the voice coil, and the welding portion being connected to the basket.

2. The sound generating device of claim 1, wherein the diaphragm, the basket, and the magnetic circuit system define a vibration space, the conductive support plate is positioned in the vibration space, the magnetic circuit system is further provided with an avoidance notch at a position corresponding to the conductive connecting member, the avoidance notch communicates the vibration space and the magnetic gap, and the avoidance notch is configured to prevent the conductive connecting member and the conductive support plate from interfering a vibration displacement of the voice coil within the magnetic gap.

3. The sound generating device of claim 2, wherein a part of the conductive connecting member is positioned in the avoidance notch and is connected to the fixing member.

4. The sound generating device of claim 2, wherein the magnetic circuit system comprises a U-shaped iron and a central magnetic circuit part, the U-shaped iron is provided with a receiving groove, the central magnetic circuit part is positioned in the receiving groove and spaced apart from a side wall of the receiving groove and the magnetic gap is formed therebetween, and the avoidance notch is provided on a side wall of the U-shaped iron.

5. The sound generating device of claim 4, wherein an angle of the avoidance notch is in a range from 15° to 27°, and/or
wherein the elastic arm extends around an outer peripheral side of the U-shaped iron.

6. The sound generating device of claim 2, wherein the sound generating device comprises a plurality of conductive connecting members, the plurality of conductive connecting members are arranged at intervals on the outer surface and distributed at intervals along the circumferential direction of the voice coil, and the magnetic circuit system is provided with a plurality of avoidance notch respectively corresponding to each of the plurality of conductive connecting members, and
wherein the sound generating device comprises a plurality of conductive support member, and the fixing member of each of the plurality of conductive support plate is connected to a respective conductive connecting member.

7. The sound generating device of claim 6, wherein a plurality of elastic arms of the plurality of conductive support plate extend along a same circumferential direction of the voice coil, and/or
wherein the voice coil has a cylindrical shape, the sound generating device comprises four conductive connecting members and four conductive support plate, and the four conductive connecting members are spaced apart and evenly distributed along the circumferential direction of the voice coil, such that an included angle formed by lines connecting any two adjacent conductive connecting members and a center of the voice coil is 90°, or, three conductive connecting members are comprised, and the three conductive connecting members are spaced apart and evenly distributed along the circumferential direction of the voice coil, such that an included angle formed by lines connecting any two adjacent conductive connecting members and the center of the voice coil is 120°, and/or
wherein the voice coil has a cylindrical shape and has a diameter of 14 mm to 28 mm, and/or
wherein the diaphragm has a diameter of 40 mm to 75 mm, and/or
wherein the voice coil comprises a bobbin and a voice coil wire disposed on the bobbin, and/or
wherein the vibration displacement of the voice coil ranges from 1 mm to 15 mm.

8. The sound generating device of claim 1, wherein the sound generating device comprises a plurality of conductive support plates, each of the plurality of elastic arms comprises a first arc segment, a second arc segment and a third arc segment connected in sequence, the first arc segment is connected to the fixing member, the third arc segment is connected to the welding portion, and the second arc segment extends from the first arc segment to the third arc segment along the circumferential direction of the voice coil, such that the third arc segment and the welding portion of a respective conductive support plate correspond to and are spaced apart from the fixing member of another conductive support plate.

9. The sound generating device of claim 8, wherein curvature centers of the first arc segment and the second arc segment and a curvature center of the third arc segment are located on opposite sides of the second arc segment,
wherein an arc angle of the first arc segment is greater than 90°, and an arc angle of the second arc segment is less than 90°, and/or
wherein a minimum gap distance between the third arc segment and the fixing member of another conductive support plate is greater than 1 mm.

10. The sound generating device of claim 8, wherein a width of the first arc segment gradually decreases from the fixing member to the second arc segment, a width of the second arc segment gradually decreases from the first arc segment to the third arc segment, and a width of the third arc segment gradually increases from the second arc segment toward an end away from the second arc segment, or
wherein the width of the first arc segment is constant from the fixing member to the second arc segment, the width of the second arc segment gradually decreases from the first arc segment to the third arc segment, and the width of the third arc segment gradually increases from the second arc segment toward an end away from the second arc segment, or
wherein the width of the first arc segment is constant from the fixed portion to the second arc segment, the width of the second arc segment decreases first and then increases from the first arc segment to the third arc segment, and the width of the third arc segment gradually increases from the second arc segment toward an end away from the second arc segment, or
wherein the width of the first arc segment, the width of the second arc segment, and the width of the third arc segment are the same.

11. The sound generating device of claim 1, wherein a width of the fixing member ranges from 1 mm to 3 mm, and/or
wherein a width of the elastic arm ranges from 1 mm to 3 mm, and/or
wherein the conductive support plate has a thickness ranging from 0.3 mm to 1 mm, and/or
wherein a length of the conductive support plate is ≥30 mm, and/or
wherein a mechanical stiffness Kms of the conductive support plate ranges from 0.1 N/mm to 1 N/mm.

12. The sound generating device of claim 1, wherein the conductive support plate comprises:
a FPCB layer having a first surface and a second surface opposite to each other, and
a reinforcing layer adhered to the first surface and/or the second surface by an adhesive layer.

13. The sound generating device of claim 12, wherein the adhesive layer is a thermosetting adhesive or an acrylic adhesive, and/or
wherein the reinforcing layer is made of at least one of PI, PEN, PET and PEI, and/or
wherein the reinforcing layer has a thickness ranging from 0.1 mm to 0.5 mm, and/or
wherein the adhesive layer has a thickness ranging from 0.015 mm to 0.1 mm.

14. The sound generating device of claim 12, wherein the FPCB layer comprises a substrate layer, a copper layer, and a cover film layer stacked in sequence, a side of the substrate layer facing away from the copper layer forms the first surface, and a side of the cover film layer facing away from the copper layer forms the second surface, or
wherein the FPCB layer comprises a substrate layer, two copper layers, and two cover film layers, the substrate layer is sandwiched between the two copper layers, each of the two cover film layers is disposed on a side of each of the two copper layers facing away from the substrate layer, and a side of the cover film layer facing away from the copper layer forms the first surface or the second surface.

15. The sound generating device of claim 1, wherein the conductive connecting member comprises a first connecting portion and a second connecting portion arranged at an angle, the first connecting portion is connected to the outer surface, and the second connecting portion is connected to the fixing member.

16. The sound generating device of claim 15, wherein the first connection portion and the second connection portion are provided perpendicular to each other, and/or
wherein the second connecting portion is connected to an end of the first connecting portion close to the diaphragm, and the fixing member is perpendicular to the outer surface of the voice coil, and/or
wherein a width of the second connecting portion is greater than a width of the first connecting portion, and/or
wherein the width of the first connecting portion gradually decreases from an end adjacent to the second connecting portion to an end away from the second connecting portion, and/or
wherein the width of the second connecting portion is the same as a width of the fixing member, and/or
wherein the outer surface is provided with an inner pad at a position corresponding to the conductive connecting member, and the first connecting portion is welded to the inner pad, and/or
wherein the conductive connecting member is a metal sheet, and/or
wherein the conductive connecting member has a thickness ranging from 0.1 mm to 0.5 mm.

17. The sound generating device of claim 15, wherein an end of the second connecting portion away from the first connecting portion is bent toward a direction away from the first connecting portion to form a support bracket, the support bracket is configured to support an end of the elastic arm adjacent to the fixing member, or
wherein an end of the second connecting portion away from the first connecting portion is bent toward a side of the fixing member to form a flange, the flange and the second connecting portion define a mounting groove, and the fixing member is accommodated and positioned in the mounting groove, or
wherein an end of the second connecting portion away from the first connecting portion is provided with a welding hole for connecting the second connecting portion and the fixing member by welding.

18. The sound generating device of claim 1, wherein the basket is provided with an outer pad, the welding portion is connected to the outer pad, the basket is provided with an avoidance hole corresponding to the outer pad, and the welding portion is connected to the outer pad through the avoidance hole, or
wherein the basket has an opening and a support portion located in the opening, and the welding portion is fixed to the support portion and connected to an external circuit.

19. The sound generating device of claim 1, wherein the basket has an opening and a support portion located in the opening, and the welding portion is fixed to the support portion and connected to an external circuit, and
wherein the welding portion is provided with a positioning hole, and the support portion is provided with a positioning pin configured to couple with the positioning hole; and/or two support portions spaced apart from each other are comprised, and a spacing therebetween forms a welding groove for welding the welding portion with an external circuit; and/or the basket comprises a bottom wall and a side wall, and the opening is disposed on the side wall and extends to the bottom wall.

20. The sound generating device of claim 1, wherein a resonant frequency F0 of the sound generating device ranges from 30 Hz to 300 Hz, and a total harmonic distortion THD of the sound generating device is less than 15%, or
wherein a resonant frequency F0 of the sound generating device ranges from 100 Hz to 300 Hz, the total harmonic distortion THD of the sound generating device is less than 10%, or
wherein a resonant frequency F0 of the sound generating device is 200 Hz, the total harmonic distortion THD of the sound generating device is less than 2.5%, or
wherein a resonant frequency F0 of the sound generating device is 300 Hz, the total harmonic distortion THD of the sound generating device is less than 2%.
